(19) United States
(12) Patent Application Publication
(10) Pub. No.: US 2024/0194174 A1
(43) Pub. Date: Jun. 13, 2024

(54) ACTIVE NOISE CANCELLATION IN A MEDICAL ENVIRONMENT

(71) Applicant: Stryker Corporation, Kalamazoo, MI (US)

(72) Inventors: Neel MISTRY, Haslet, TX (US); Aurelien CHIRON, Santa Clara, CA (US)

(73) Assignee: Stryker Corporation, Kalamazoo, MI (US)

(21) Appl. No.: 18/537,744

(22) Filed: Dec. 12, 2023

Related U.S. Application Data
(60) Provisional application No. 63/387,271, filed on Dec. 13, 2022.

(51) Int. Cl. G10K 11/178; G10L 15/00

(52) U.S. Cl. CPC G10K 11/17823; G10K 11/17873; G10L 15/00

(57) ABSTRACT

Disclosed herein are systems and methods for actively cancelling noise within a medical environment comprising human speech and other sounds. The human speech may be a verbal command from a user, verbal information for telestration or teleconferencing purposes, etc. The medical environment may comprise one or more speakers, a microphone system, and other components of an audio system. The speakers may play a sound corresponding to a speaker audio signal, generated from a source audio signal from a sound source. The microphone system captures an audio signal comprising the sound played by the speaker(s), the human speech, and/or noise from equipment in the medical environment. The microphone system and/or a computing device then modifies the captured audio signal for active noise cancellation. The disclosed systems and methods may be able to accurately decipher the human speech and cause one or more corresponding actions to be performed.

### CROSS-REFERENCE TO RELATED APPLICATIONS

This application claims the benefit of U.S. Provisional Application No. 63/387,271, filed Dec. 13, 2022, the entire contents of which are hereby incorporated by reference herein.

### FIELD

The present invention relates to active noise cancellation, particularly for speech recognition, in a medical environment.

### BACKGROUND

Operating rooms include many devices that assist users (e.g., surgeon, medical staff, etc.) in performing surgical procedures. Such devices include, for example, surgical lights, endoscopic cameras, insufflators, touch panels, and servers. In some instances, a user may verbally communicate information to an audio source, such as verbal commands to control one or more medical devices or information for telestration or teleconferencing purposes. For example, the user may wear a headset during a surgical procedure and say a verbal command that corresponds to controlling equipment in the medical environment (e.g., “increase the brightness of the lights,” or “turn off the shaver”). A microphone on the headset worn by the user may receive the verbal command and cause the equipment to act accordingly.

The user may wear a wireless headset, making it easier for the user to move freely without having to deal with wires. However, the wireless headset may still be uncomfortable and burdensome; it can be prone to falling off the user's head, the user may not be able to adjust it during a surgical procedure, etc. The user needs to be able to comfortably perform the surgical procedure while having the capability of verbally communicating information. One solution may be to use a microphone that does not have be worn by the user. The microphone can be located on one or more fixtures or equipment located in the operating room. The operating room may also include speakers, typically used to play one or more sounds (e.g., music) during a surgical procedure. Thus, it is important to be able to decipher the user's speech in a medical environment, filled with other sounds.

### SUMMARY

According to various aspects, systems and methods include actively cancelling noise within a medical environment from an audio signal comprising human speech and other sounds. The human speech may be a verbal command from a user, verbal information for telestration or teleconferencing purposes (e.g., a teleconference session with a pathologist conducting a biopsy during a surgical procedure), or the like. The medical environment may comprise one or more speakers, a microphone system, and other components of an audio system. The speakers may play a sound (e.g., music) corresponding to a speaker audio signal, generated from a source audio signal from a sound source. The microphone system captures an audio signal comprising the sound played by the speaker(s), the human speech, and/or noise from equipment in the medical environment. The microphone system and/or a computing device then modifies the captured audio signal for active noise cancellation. The disclosed systems and methods may be able to accurately decipher the human speech and cause one or more corresponding actions to be performed.

According to some examples, a method of performing active noise cancellation in a medical environment comprises: playing, by one or more speakers, a sound within the medical environment; capturing, using a microphone system, an audio signal comprising the sound played by the one or more speakers; receiving, at the microphone system, a reference sound signal from a reference source; and modifying at least a portion of the captured audio signal based on the reference sound signal.

In any of the examples, the microphone system comprises a microphone that is not worn by a human.

In any of the examples, the captured audio signal further comprises human speech or noise from equipment in the medical environment.

In any of the examples, the method further comprises: receiving a source audio signal from a sound source, wherein the sound source is communicatively coupled to the reference source.

In any of the examples, the method further comprises: receiving a source audio signal from a sound source, wherein the sound source is communicatively coupled to the reference source via a line, Ethernet, or an X latching resilient (XLR) cable.

In any of the examples, the method further comprises: receiving a source audio signal from a sound source; and encoding and decoding, using an encoder and a decoder, the source audio signal, wherein the sound source is communicatively coupled to the encoder and the decoder.

In any of the examples, the method further comprises: receiving a source audio signal from a sound source; and encoding and decoding, using an encoder and a decoder, the source audio signal, wherein the sound source is communicatively coupled to the encoder and the decoder via a line, Ethernet, or an X latching resilient (XLR) cable.

In any of the examples, the method further comprises: receiving a source audio signal from a sound source; and converting, using one or more audio converters, the source audio signal from one format to another format, wherein the sound source is communicatively coupled to the one or more audio converters.

In any of the examples, the method further comprises: receiving a source audio signal from a sound source; and converting, using one or more audio converters, the source audio signal from one format to another format, wherein the sound source is communicatively coupled to the one or more audio converters via a line, Ethernet, or an X latching resilient (XLR) cable.

In any of the examples, the method further comprises: receiving a source audio signal from a sound source; and generating the reference sound signal and a speaker audio signal based on the source audio signal, wherein the speaker audio signal corresponds to the sound played by the one or more speakers.

In any of the examples, the method further comprises: receiving a source audio signal from a sound source; and generating the reference sound signal and a speaker audio signal based on the source audio signal, wherein the speaker audio signal corresponds to the sound played by the one or more speakers, wherein the reference sound signal and the speaker audio signal are copies of the source audio signal.

In any of the examples, the method further comprises: receiving a source audio signal from a sound source; generating the reference sound signal and a speaker audio signal based on the source audio signal, wherein the speaker audio signal corresponds to the sound played by the one or more speakers; communicating the reference sound signal to the microphone system; and communicating the speaker audio signal to the one or more speakers.

In any of the examples, the method further comprises: receiving a source audio signal from a sound source; and communicating the source audio signal to the microphone system, wherein the source audio signal comprises the reference sound signal and a speaker audio signal corresponding to the sound played by the one or more speakers.

In any of the examples, the reference sound signal is received at the microphone system through a connection between the microphone system and an audio mixer.

In any of the examples, the reference sound signal is received at the microphone system through a connection between the microphone system and an audio converter.

In any of the examples, the reference sound signal is received at the microphone system through a connection between the microphone system and a computing device.

In any of the examples, the reference source comprises an audio mixer, an audio converter, or a computing device.

In any of the examples, the method further comprises: communicating a speaker audio signal corresponding to the sound played by the one or more speakers across a line, Ethernet, or an X latching resilient (XLR) cable.

In any of the examples, the method further comprises: amplifying a speaker audio signal corresponding to the sound played by the one or more speakers.

In any of the examples, the method further comprises: communicating the modified audio signal to a computing device using a USB, fiber optic coupling, or both.

In any of the examples, the method further comprises: converting the modified audio signal from: an optical signal to an electrical signal, an electrical signal to an optical signal, or both.

In any of the examples, modifying at least a portion of the captured audio signal comprises modifying the captured audio signal using the microphone system.

In any of the examples, modifying at least a portion of the captured audio signal comprises modifying the captured audio signal using both the microphone system and a computing device.

In any of the examples, modifying at least a portion of the captured audio signal comprises: processing the modified audio signal using speech recognition, recording speech as an audio file, communicating speech to another device, or a combination thereof.

In any of the examples, the method excludes a calibration process.

According to some examples, a system for performing active noise cancellation in a medical environment comprises: one or more speakers configured to play a sound within the medical environment; a path for communicating a reference sound signal from a reference source to a microphone system; and the microphone system comprising: a microphone configured to capture an audio signal comprising the sound played by the one or more speakers; and a microphone controller configured to modify at least a portion of the captured audio signal based on the reference sound signal.

In any of the examples, the microphone is not worn by a human. The microphone can be positioned remote from the human.

In any of the examples, the captured audio signal further comprises human speech or noise from equipment in the medical environment.

In any of the examples, the system further comprises: a sound source configured to generates a source audio signal, wherein the sound source comprises a computing device.

In any of the examples, the system further comprises: a sound source communicatively coupled to the reference source through a line, Bluetooth, Ethernet, or an X latching resilient (XLR) cable.

In any of the examples, the system further comprises: an encoder and a decoder configured to encode and decode a source audio signal from a sound source.

In any of the examples, the system further comprises: an encoder and a decoder configured to encode and decode a source audio signal from a sound source, wherein the encoder is an audio/video over IP encoder, and the decoder is an audio/video over IP decoder.

In any of the examples, the system further comprises: one or more audio converters configured to convert a source audio signal from a sound source from one format to another format.

In any of the examples, the system further comprises: a plurality of audio converters configured to convert a source audio signal from a sound source from one format to another format, wherein at least two of the plurality of audio converters are connected through a path having a length that is less than 102 feet.

In any of the examples, the reference source comprises an audio mixer, an audio converter, or a computing device.

In any of the examples, the microphone system is connected to the reference source through a copper wire, a fiber optic cable, Bluetooth, or an Ethernet cable.

In any of the examples, the system further comprises: an audio mixer configured to: receive a source audio signal from a sound source; and generate the reference sound signal and a speaker audio signal based on the source audio signal, wherein the speaker audio signal corresponds to the sound played by the one or more speakers.

In any of the examples, the system further comprises: an audio mixer configured to: receive a source audio signal from a sound source; generates the reference sound signal and a speaker audio signal based on the source audio signal, wherein the speaker audio signal corresponds to the sound played by the one or more speakers; communicates the reference sound signal to the microphone system; and communicates the speaker audio signal to the one or more speakers.

In any of the examples, the system further comprises: an audio mixer communicatively coupled to a sound source through a line, Ethernet, or an X latching resilient (XLR) cable.

In any of the examples, the system further comprises: an audio mixer connected to a sound source through a path having a length that is less than 15 feet.

In any of the examples, the system further comprises: an audio mixer communicatively coupled to the one or more speakers through one or more X latching resilient (XLR) cables.

In any of the examples, the system further comprises: an amplifier configured to amplify a speaker audio signal corresponding to the sound played by the one or more speakers.

In any of the examples, the system further comprises: an amplifier connected to an audio converter through a path having a length that is less than 102 feet.

In any of the examples, the system further comprises: an amplifier connected to the one or more speakers through a path having a length that is less than 75 feet.

In any of the examples, the system further comprises: a splitter configured to: receive a source audio signal from a sound source; and generate the reference sound signal and a speaker audio signal based on the source audio signal, wherein the speaker audio signal corresponds to the sound played by the one or more speakers.

In any of the examples, the system further comprises: a splitter configured to: receive a source audio signal from a sound source; and generate the reference sound signal and a speaker audio signal based on the source audio signal, wherein the reference sound signal corresponds to the speaker audio signal.

In any of the examples, the system further comprises: a splitter configured to: receive a source audio signal from a sound source; and generate the reference sound signal and a speaker audio signal based on the source audio signal, wherein the speaker audio signal corresponds to the sound played by the one or more speakers; and one or more audio converters configured to: convert the reference sound signal from one format to another format; communicate the converted reference sound signal to the microphone system; convert the speaker audio signal from one format to another format; and communicate the converted speaker audio signal to the one or more speakers.

In any of the examples, the system further comprises: a computing device configured to: receive a source audio signal from a sound source; and communicate the source audio signal to the microphone system, wherein the source audio signal comprises the reference sound signal and a speaker audio signal corresponding to the sound played by the one or more speakers.

In any of the examples, the system further comprises: a computing device configured to: receive a source audio signal from a sound source; and communicate the source audio signal to a splitter, wherein the source audio signal comprises the reference sound signal and a speaker audio signal corresponding to the sound played by the one or more speakers.

In any of the examples, the system further comprises: a computing device configured to modify the modified audio signal.

In any of the examples, the system further comprises: a computing device configured to process the modified audio signal using speech recognition, records speech as an audio file, communicates speech to another device, or a combination thereof.

In any of the examples, the system further comprises: a computing device communicatively coupled to the microphone system through a fiber optic cable or a USB cable.

In any of the examples, the system further comprises: a computing device communicatively coupled to the microphone system through a path having a length that is less than 328.08 feet.

In any of the examples, the system further comprises: an optical-to-electrical converter configured to convert the modified audio signal from an optical signal to an electrical signal.

In any of the examples, the system further comprises: an electrical-to-optical converter configured to convert the modified audio signal from an electrical signal to an optical signal.

In any of the examples, the microphone system comprises a far field microphone array or a microphone mesh.

In any of the examples, the microphone system comprises the one or more speakers.

In any of the examples, the system further comprises: one or more multimedia cables for routing one or more signals to or from the microphone system through a suspension.

In any of the examples, the system further comprises: one or more multimedia cables for connecting the microphone system to the reference source.

In any of the examples, the system further comprises: one or more additional microphone systems configured to capture noises from equipment within the medical environment, wherein the reference sound signal comprises the captured noise.

In any of the examples, the system further comprises: a computing device configured to: receive a plurality of modified audio signals from a plurality of microphone systems; and select a noise-cancelled audio signal having the best speech quality from among the plurality of modified audio signals.

In any of the examples, the medical environment comprises an operating room.

According to some examples, a suspension comprises: a microphone system comprising: one or more speakers configured to play a sound within a medical environment; a microphone configured to capture an audio signal comprising the sound played by the one or more speakers; and a microphone controller configured to modify at least a portion of the captured audio signal based on a reference sound signal; and at least one cable for communicating the captured audio signal, the reference sound signal, and the modified audio signal.

It will be appreciated that any of the variations, aspects, features, and options described in view of the systems apply equally to the methods and suspension, and vice versa. It will also be clear that any one or more of the above variations, aspects, features, and options can be combined.

### BRIEF DESCRIPTION OF THE FIGURES

The invention will now be described, by way of example only, with reference to the accompanying drawings, in which:

FIG. 1 illustrates an example operating room, according to some aspects.

FIG. 2 illustrates a block diagram of an example audio system of a medical environment, according to some aspects.

FIG. 3 illustrates an example suspension, according to some aspects.

FIG. 4 illustrates a flowchart of an example method for performing active noise cancellation in an operating room, according to some aspects.

FIG. 5 illustrates a block diagram of an example audio system comprising additional components, according to some aspects.

FIG. 6 illustrates a block diagram of an example audio system that communicates the reference sound signal to the microphone directly from an amplifier, according to some aspects.

FIG. 7 illustrates a block diagram of an example audio system and microphone comprising one or more speakers, according to some aspects.

FIG. 8A illustrates an example block diagram depicting a voiceprint enrollment mode, according to some aspects.

FIG. 8B illustrates an example block diagram depicting a voiceprint authentication mode, according to some aspects.

FIG. 9 illustrates a block diagram of an example system configured for using one or more voiceprints for noise reduction, according to some aspects.

FIG. 10 illustrates an example configuration of an operating room, according to some aspects of the disclosure.

FIG. 11 illustrates an example computing system used for performing any of the methods and systems described herein, according to some aspects.

### DETAILED DESCRIPTION

Reference will now be made in detail to implementations and various aspects and variations of systems and methods described herein. Although several example variations of the systems and methods are described herein, other variations of the systems and methods may include aspects of the systems and methods described herein combined in any suitable manner having combinations of all or some of the aspects described.

Systems and methods according to the principles described herein accurately perform active noise cancellation in a medical environment, including noise cancellation that is performed in a continuous and real-time manner. The systems and methods can reliably cancel sounds from within the medical environment to determine human speech. For example, active noise cancellation can be used to determine a verbal command from a user (e.g., surgeon, medical staff, etc.) or verbal information conveyed for telestration or teleconferencing purposes. The disclosed system may comprise a microphone system that captures an audio signal comprising the sound played by one or more speakers within a medical environment, where the microphone is not worn by a human. Conventional noise cancellation techniques do not involve active noise cancellation, require a human to wear a headset, and/or are prone to misinterpreting human speech. Examples of the disclosed system may be capable of accurately performing active noise cancellation in a medical environment where the microphone is not worn by a human.

The systems may comprise a microphone controller and/or a computing device that perform the active noise cancellation using a captured audio signal and a reference sound signal. The reference sound signal is communicated along a path between the microphone system and a reference source (e.g., an audio mixer, an audio converter, or a computing device). In some aspects, the path may comprise a direct connection (e.g., a connection between two components without any intermediate components). The direct connection may reduce the amount of lag between the captured audio signal and the reference sound signal, thereby improving the accuracy of the active noise cancellation.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like, refer to the actions and processes of a computer system, or similar electronic computing device, that manipulates and transforms data represented as physical (electronic) quantities within the computer system memories or registers or other such information storage, transmission, or display devices.

The present disclosure in some examples also relates to a device for performing the operations herein. This device may be specially constructed for the required purposes, or it may comprise a general-purpose computer selectively activated or reconfigured by a computer program stored in the computer. Such a computer program may be stored in a non-transitory, computer-readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application-specific integrated circuits (ASICs), or any type of media suitable for storing electronic instructions, and cach coupled to a computer system bus. Furthermore, the computers referred to in the specification may include a single processor or may be architectures employing multiple processor designs for increased computing capability. Suitable processors include central processing units (CPUs), graphical processing units (GPUs), field-programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear in the description below. In addition, the present invention is not described with reference to any particular programming language. It will be appreciated that a variety of programming languages may be used to implement the teachings of the present invention as described herein.

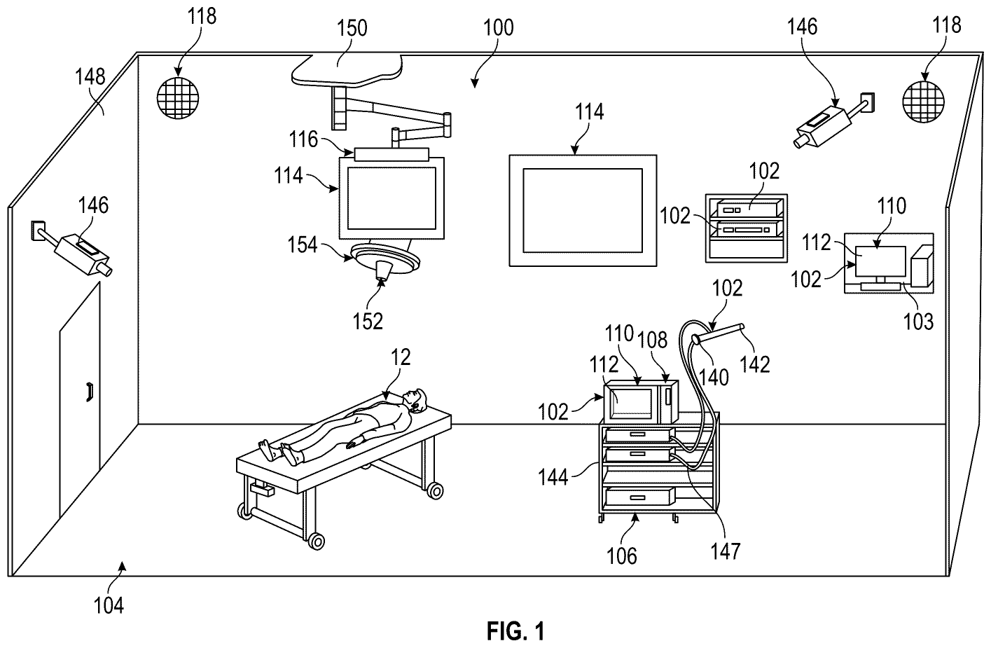

FIG. 1 illustrates an example operating room, according to some aspects. The operating room 100 comprises at least one medical device 102 to assist in performing a medical or surgical procedure and/or for recordkeeping purposes. For example, the medical device 102 may be used to input or receive (e.g., from electronic medical records (EMRs), from electronic health records (EHRs), from hospital information systems (HISs), or communicated in real time from another system) patient information, e.g., for use with information or images saved on the medical device 102, displaying information or images from the medical device 102, sending information or images to other medical devices 102, or a combination thereof. In some aspects, the medical device 102 may be used to record patient information, including storing the information or images in an EMR, an EHR, an HIS system, or other type of file or system.

The medical device 102 located in the operating room 100 can include any device that is capable of saving information related to a subject 12. The medical device 102 may or may not be coupled to a network that includes records of the subject 12. The medical device 102 may include a computer system 110 (e.g., a desktop computer, a laptop computer, or a tablet device) having an application server. The computer system 110 can have a motherboard that includes one or more processors or other similar control devices as well as one or more memory devices. The processor controls the overall operation of the computer system 110 and can include hardwired circuitry, programmable circuitry that executes software, or a combination thereof. The processor may, for example, execute software stored in the memory device. The processor may include, for example, one or more general- or special-purpose programmable microprocessors and/or microcontrollers, ASICs, programmable logic devices (PLDs), programmable gate arrays (PGAs), or the like. The memory device may include any combination of one or more RAMs, ROMs (which may be programmable), flash memory, and/or other similar storage devices. Patient information may be inputted into the computer system 110 for use with the computer system 110 (e.g., for making an operative note during the medical or surgical procedure on the subject 12 in the operating room 100) and/or the computer system 110 can transmit the patient information to another medical device 102 (via either a wired connection or wirelessly).

The medical device 102 can be positioned in the operating room 100 on a table (stationary or portable), a floor 104, a portable cart 106, an equipment boom, and/or shelving 103. FIG. 1 illustrates a plurality of computer systems 110: a first computer system 110 in the form of desktop computer shelving 103 and a second computer system 110 incorporated into a computing device 108 (e.g., an image and video capture device) on a portable cart 106. It is contemplated that the computer system 110 can be on the portable cart 106 (e.g., on the same cart 106 as the computing device 108 or on a separate cart). Further, examples of the disclosure may include any number of computer systems 110.

In some aspects, the operating room 100 may be an integrated suite used for minimally invasive surgery (MIS) or fully invasive procedures. Video and audio components and associated routing are located throughout the operating room 100. The components are located on or within the walls 148, ceilings 150, or floors 104 of the operating room 100. Wires, cables, and hoses are routed through suspensions, equipment booms, and/or interstitial space. The wires, cables, and/or hoses in the operating room 100 may be capable of connecting to mobile equipment, such as the portable cart 106 (e.g., C arms or microscopes) communicating routing audio, video, and data information.

The computing device 108 routes audio, video, and data information (e.g., device control) throughout the operating room 100. The computing device 108 and/or associated router(s) may route the information between devices within or proximate to the operating room 100. In some aspects, the computing device 108 and/or associated router(s) (not shown) may be located in a room outside the operating room 100, such as in a closet located, e.g., within 328.08 feet (or 100 meters). In some other aspects, the computing device 108 and/or associated router(s) (not shown) may be located in a cabinet inside the operating room 100 or adjacent to it (e.g., within 75 feet from the top of a medical suspension drop tube).

The computing device 108 may be capable of recording images, recording videos, displaying images, displaying videos, recording audio, outputting audio, or a combination thereof. In some aspects, patient information can be input into the computing device 108 for adding to the images and videos recorded and/or displayed by the computing device 108. The computing device 108 can include internal storage (e.g., a hard drive or a solid-state drive) for storing the captured images and videos. The computing device 108 can also display captured or saved images (e.g., from the internal hard drive) or display the images on an associated touchscreen monitor 112 and/or an additional monitor 114 coupled to the computing device 108 via either a wired connection or wirelessly. It is contemplated that the computing device 108 could obtain or create images of the subject 12 during a medical or surgical procedure from a variety of sources (e.g., from video cameras, video cassette recorders, X-ray scanners (which convert X-ray films to digital files), digital X-ray acquisition apparatus, fluoroscopes, computed tomography (CT) scanners, magnetic resonance imaging (MRI) scanners, ultrasound scanners, charge-coupled devices (CCD), and other types of scanners (handheld or otherwise)). If coupled to a network, the computing device 108 can also communicate with a picture archiving and communication system (PACS), as is well known to those skilled in the art, to save images and video in the PACS and for retrieving images and videos from the PACS. The computing device 108 can couple and/or integrate with, e.g., an electronic medical records database and/or a media asset management database.

A touchscreen monitor 112 and/or an additional monitor 114 are capable of displaying images and videos captured live by cameras (e.g., a video camera 140 coupled to an associated endoscope 142, which communicates with a camera control unit 144 via a cable 147, with the camera control unit 144 communicating via wires or wirelessly with the computing device 108) and/or replayed from recorded images and videos. It is further contemplated that the touchscreen monitor 112 and/or additional monitor 114 may display images and videos captured live by a room camera 146, e.g., fixed to walls 148 or a ceiling 150 of the operating room 100 (e.g., a room camera 146 as shown or a camera 152 in an overhead light 154). The images and videos may be routed from the cameras to the computing device 108, to the touchscreen monitor 112, and/or to the additional monitor 114.

One or more speakers 118 are positioned within the operating room 100 to provide sounds, such as music, audible information, and/or alerts to be played within the medical environment during the surgical procedure. For example, the speaker(s) 118 may be ceiling speakers, bookshelf speakers, speakers on a station, etc. One or more microphone systems 116 capture audio signals within the medical environment. The captured audio signals may comprise the sound played by the speakers 118, human speech (e.g., verbal commands to control one or more medical devices or verbal information conveyed for telestration or teleconferencing purposes), and/or noise, e.g., from equipment in the operating room 100. The microphone system 116 may for instance be located within a speaker (e.g., a smart speaker) attached to the monitor 114, as shown in the figure, and/or within the housing of the monitor 114.

Aspects of the disclosure comprise a user device that could be a portable wireless device that supports hands-free, voice communications. The user device could include one or more microphones that receive voice commands and other voice input from a user, and one or more speakers that generate audible output signals. Further, the user device could include a wireless transceiver, enabling the device to connect with the network and engage in communication through the system. In some aspects, the user device could be powered by a rechargeable battery, and could include one or more microphones for receiving voice or other audio input, and one or more speakers and/or other interfaces for outputting voice or other audio. The user device could include one or more LEDs, haptic actuators, and/or other mechanisms for presenting visual, haptic, or other indications or alerts to the user. The user device could include a WiFi transceiver or other wireless transceiver to enable the user device to communicate with the central computing system (including computing device 108).

Aspects of the disclosure comprise the user device switching to different power states to conserve battery. The user may utter a predefined wake word to wake up a user device, in response to which the user device could then transition to a full-power state in order to engage in various device operations. The noise reduction techniques described herein may be applied to the audio waveform representing the wake-word utterance. This noise reduction may help to effeetively narrow or focus the received audio by filtering out some noise. In some aspects, a relatively higher degree of noise reduction may be applied for wake-word detection than as to other received audio, to help avoid waking up the user device if an uttered wake word does not come from the user of the device.

The microphone system 116 may communicate via wires or wirelessly with the computing device 108. The microphone system 116 and/or computing device 108 may communicate, record, and/or modify the captured audio signal. For example, the computing device 108 may communicate a speaker audio signal corresponding to the sound played by the speakers 118. The microphone system 116 captures the audio signal comprising the sound played by the speakers 118 and modifies at least a portion of the captured audio signal for speech recognition. The computing device 108 may record the user's speech for telestration or teleconferencing purposes (e.g., record verbal information for educational purposes, make room calls, or send real-time information to pathologists (for conducting a biopsy during a surgical procedure, for example)). Additionally or alternatively, the computing device 108 is capable of modifying the captured audio signal, including recognizing a verbal command received from the user (e.g., surgeon, medical staff, etc.).

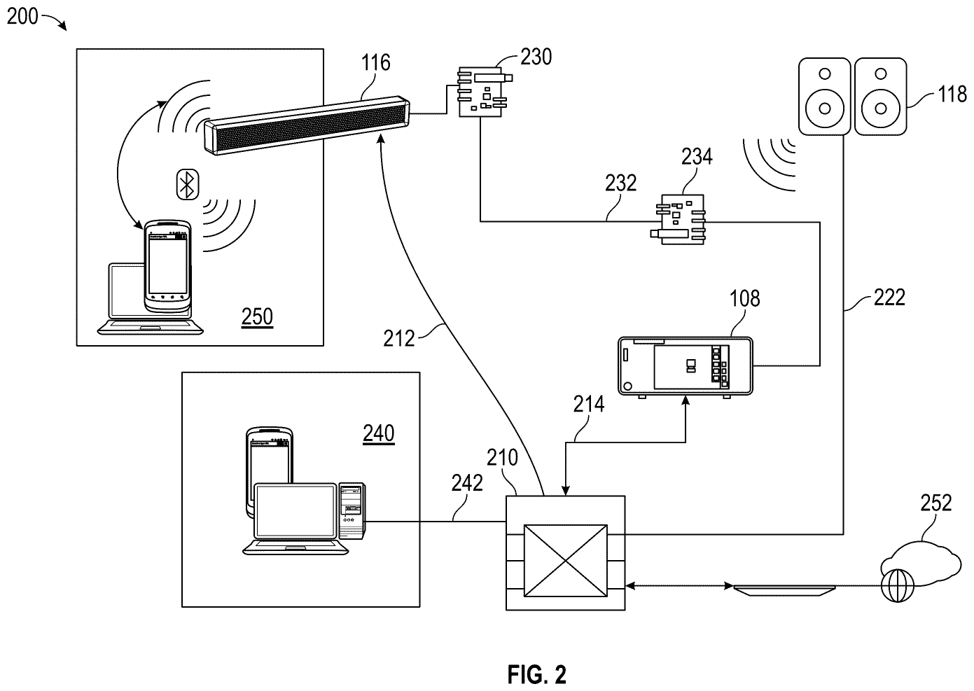

FIG. 2 illustrates a block diagram of an example audio system in a medical environment (e.g., an operating room), according to some aspects. The audio system 200 may include one or more speakers 118 for playing a sound (e.g., music) in an operating room 100. The speakers 118 receive, from a sound source (e.g., a computing device 240, an audio mixer 210, or a computing device 108), a speaker audio signal corresponding to the sound to be played by the speakers 118. The speaker audio signal is generated from a source audio signal from a sound source. The speakers 118 may be ceiling speakers, bookshelf speakers, speakers on a station, or the like.

The audio system 200 may also include a microphone system 116 for capturing an audio signal in the operating room 100. The captured audio signal comprises sounds in the operating room 100, such as the sound played by the speakers 118, human speech from a user (e.g., surgeon, medical staff, etc.), and/or noise such as from equipment (e.g., one or more medical devices) in the operating room 100. In some aspects, the microphone system 116 constantly captures the audio signal in the operating room 100. In some aspects, the microphone system 116 comprises a far field microphone array or a microphone mesh system.

The microphone system 116 comprises a microphone controller that receives a reference sound signal from a reference source. In some aspects, the reference sound signal is communicated directly to the microphone system 116. The reference source comprises an audio mixer 210, an audio converter, and/or a computing device 240. The microphone system 116 and/or computing device 108 perform active noise cancellation by modifying the captured audio signal based on the reference sound signal. For example, the microphone system 116 and/or computing device 108 may remove the reference sound signal from the captured audio signal. In some aspects, the modification cancels noise (e.g., background music, device noise, or acoustic feedback) from the captured audio signal.

In some aspects, the microphone system 116 receives the reference sound signal via a path comprising a direct connection (e.g., a connection between two components without any intermediate components). The direct connection may help reduce the amount of lag between the reference sound signal and any acoustic feedback in the captured audio signal. The microphone system 116 is connected to the reference source via path 212 comprising copper wire(s), a fiber optic cable, Bluetooth, or Ethernet (e.g., Software Defined Video over Ethernet (SDVoE)), as non-limiting examples. For example, the reference sound signal may be communicated from an audio mixer 210 to the microphone system 116 using a copper cable. Additionally or alternatively, the reference sound signal may be communicated from a Bluetooth or Ethernet device (e.g., smart phone or laptop) to the microphone system 116. Communicating the reference sound signal directly from the reference source to the microphone system 116 leads to enhanced accuracy of the noise-cancelled audio signal, including minimizing timing lag between the reference sound signal and the captured audio signal. Enhanced accuracy results in a higher quality signal received by the computing device 108, avoiding or reducing the need for the user to have to yell or attempt to overpower the sound played by the speakers 118 and/or erroneous processing of the captured audio signal.

The sound source may be a device (e.g., a computing device 240, such as a computer or docked phone) that generates a source audio signal comprising the sound to be played in the medical environment. The sound source is communicatively coupled to the reference source. A speaker audio signal is generated from the source audio signal, and it is communicated to the speakers 118 to be played in the operating room 100. In some aspects, the speaker audio signal is communicated directly to the component that performs active noise cancellation (e.g., the microphone system 116 and/or computing device 108). In some aspects, the audio system 200 may not include a separate sound source but, instead, the speakers 118 receive the speaker audio signal from a multi-functioning component, such as the computing device 108 or the audio mixer 210.

Additionally or alternatively, the microphone system 116 may be coupled to a computing device 250. The computing device 250 comprises a mobile device, a laptop, or the like. In some aspects, the microphone system 116 communicates with the computing device 250 using a wired or wireless (e.g., Bluetooth) connection.

The audio system 200 may include an audio mixer 210. The audio mixer 210 may receive the source audio signal from the sound source via path 242. The path 242 may have any length suitable for communicating signals with minimal or no signal loss or delays, such as less than 15 feet (although other lengths are within the scope of the disclosure). Path 242 can comprise a line, Ethernet, or X latching resilient (XLR) cable used for communicatively coupling the reference source and the sound source. In some aspects, the audio mixer 210 generates the reference sound signal and the speaker audio signal based on the source audio signal. For example, the audio mixer 210 may split the source audio signal into a plurality of audio signals, comprising the reference sound signal (communicated to the microphone system 116) and the speaker audio signal (communicated to the speakers 118). In such an instance, the audio mixer 210 is communicating the reference sound signal directly to the microphone system 116. In some aspects, the audio mixer 210 is programmable, allowing the introduction or adjustment of delays in the transmission of one or more output signals. The delays may be introduced or adjusted to, e.g., improve the accuracy of the active noise cancellation by compensating for propagation delays over long paths. As one non-limiting example, cach of the plurality of audio signals, e.g., the reference sound signal and the speaker audio signal communicated along paths 212 and 222, respectively, are copies of the source audio signal. In some aspects, path 222 comprises a line, Ethernet, an XLR cable, a Tip, Ring, and Sleeve (TRS) cable, for example.

Aspects of the disclosure comprise performing active, continuous noise cancellation by canceling the reference sound signal from the captured audio signal. The captured audio signal may comprise a noisy verbal command, for example. The microphone controller (of the microphone system 116) modifies the captured audio signal and then communicates the modified audio signal to the computing device 108 for processing. In some aspects, the microphone controller may be a dedicated microcontroller located within the chassis of the microphone system 116.

In some aspects, the computing device 108 further modifies the modified audio signal. For example, the computing device 108 processes the modified audio signal using speech recognition, records corresponding speech as an audio file, communicates the corresponding speech to another device, or a combination thereof. The modification may result in a clean verbal command, for example. In some aspects, speech recognition may be used to recognize one or more verbal commands. In some aspects, the recorded audio file may be coupled with a video file, such as a recorded training video of the surgical procedure.

The microphone system 116 communicates the modified audio signal to the computing device 108 using path 232. Path 232 comprises a fiber optic cable, USB cable, or both, for example. In some aspects, path 232 comprises one or more converters 230 and/or 234. A converter 230/234 may comprise a digital-to-analog converter or an analog-to-digital converter. A converter 230/234 may be configured to convert the modified audio signal from one format to another, such as an optical signal to an electrical signal (e.g., optical-to-electrical converter for converting an optical signal to USB signal) and/or an electrical signal to an optical signal (e.g., electrical-to-optical converter), for example. In some aspects, path 232 may comprise a USB cable from the microphone system 116 to the converter 230, a fiber optic cable (e.g., OM1, OM2, or OM3) from the converter 230 to the converter 234, and a USB cable from the converter 234 to the computing device 108. In some aspects, communicating the modified audio signal using, e.g., a fiber optic coupling allows the computing device 108 to be located further from the microphone system 116 with minimal or no signal loss, electromagnetic interference, or delays. For example, in some aspects, the computing device 108 may be communicatively coupled to the microphone system 116 through a path having a length that is less than 328.08 feet (100 meters).

Additionally or alternatively, the audio system 200 may comprise a connection to the internet 252. The internet connection may be used for audio compression purposes, for example.

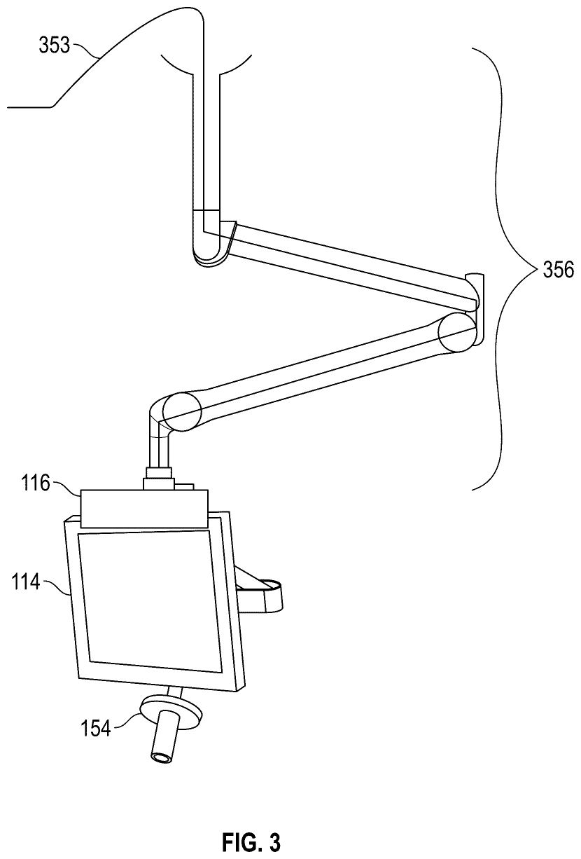

In some aspects, one or more signals from the microphone system 116 may be routed using one or more multimedia cables through a suspension, such as a suspension 356 for an overhead light 154 and/or monitor 114, as shown in FIG. 3. The suspension 356 may also be utilized for the microphone system 116. In some aspects, the suspension 356 may be a ceiling-mounted suspension. At least one cable may be routed through the suspension 356. For example, a multimedia cable 353 for connecting the microphone system 116 to the reference source (e.g., the audio mixer 210) is routed through the suspension 356. As another non-limiting example, the captured audio signal, the reference sound signal, and the modified audio signal may be communicated via the multimedia cable 353 from the microphone system 116 to the computing device 108.

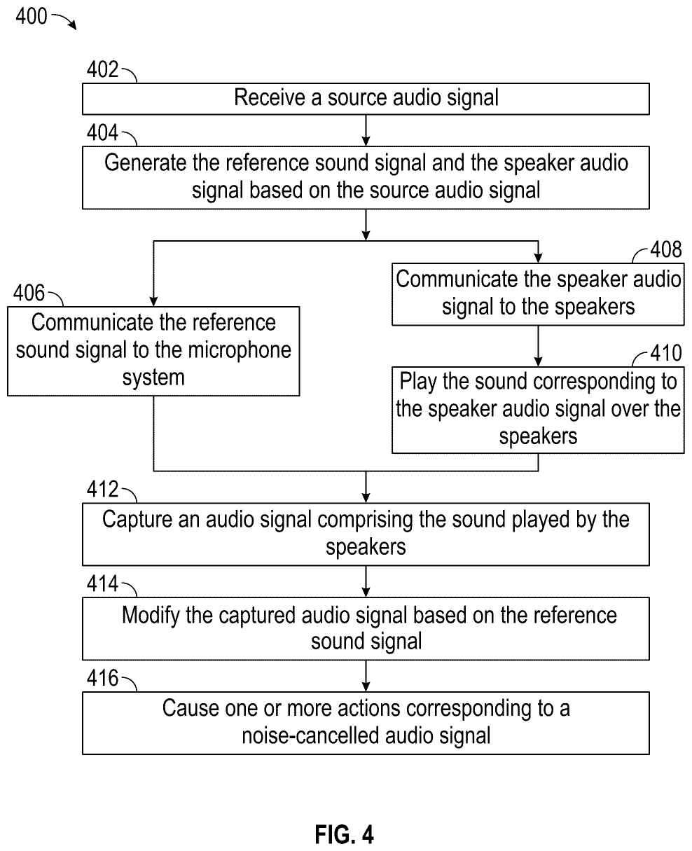

FIG. 4 illustrates a flowchart of an example method for performing active noise cancellation in a medical environment, according to some aspects. The method 400 comprises the audio system 200 receiving a source audio signal from a sound source at step 402. For example, the audio mixer 210 receives the source audio signal via path 242. The audio mixer 210 generates the reference sound signal and the speaker audio signal based on the source audio signal (step 404). The audio mixer 210 communicates the reference sound signal to the microphone system 116 via path 212 (step 406) and the speaker audio signal to the speakers 118 via path 222 (step 408). In response to receiving the speaker audio signal, in step 410, the speakers 118 play the sound corresponding to the speaker audio signal within the medical environment (e.g., an operating room 100).

In step 412, the microphone system 116 captures an audio signal comprising the sound played by the one or more speakers 118. The captured audio signal comprises the sound played by the speakers 118, human speech spoken in the operating room 100, noise such as from equipment in the operating room 100, etc. In step 414, the microphone controller (in the microphone system 116) and/or computing device 108 modifies the captured audio signal based on the reference sound signal (from the audio mixer 210), resulting in a noise-cancelled audio signal. The active noise cancellation may comprise modifying the reference sound signal (e.g., by 90 degrees), and then combining the modified reference sound signal with the captured audio signal (e.g., superposing a shifted reference sound signal waveform and the captured audio signal waveform). In some aspects, the microphone controller modifies at least a portion of the captured audio signal and communicates it to the computing device 108, where the computing device 108 further modifies the modified audio signal. The modified audio signal comprises a noise-cancelled audio signal where noise is fully or partially cancelled. In some aspects, the microphone system 116 communicates the noise-cancelled audio signal (modified audio signal) to the computing device 108. In some instances, the microphone controller communicates a noise-cancelled audio signal to the computing device 108, and the computing device 108 removes additional noise for improved noise cancellation. Examples of modifications may include, but are not limited to, removing noise, determining which verbal command the noise-cancelled audio signal corresponds to, syncing the noise-cancelled audio signal with a video signal, or the like.

Active noise cancellation may remove noise (e.g., background music or device noise) from verbal commands spoken by, e.g., a user within the medical environment. The noise may be removed by using a reference sound signal to cancel the noise from the captured audio signal, resulting in clearer speech spoken by the user. By using a reference sound signal to perform the active noise cancellation, it is less likely that the user's verbal commands will be misinterpreted.

In step 416, the computing device 108 causes one or more actions corresponding to a noise-cancelled audio signal, such as causing one or more medical devices to execute the verbal command or storing the audio signal in a file. In some aspects, the computing device 108 communicates the noise-cancelled audio signal (modified audio signal) to a computer or other external device along path 214. As one non-limiting example, the computing device 108 is coupled to the audio mixer 210 using path 214.

One or more steps of method 400 may be repeated, for example, while a surgical procedure is ongoing and/or the audio system continues to receive an audio signal from a sound source (e.g., computing device 240 or audio mixer 210).

Aspects of the disclosure may include a method for performing a recalibration process of the reference sound signal to account for a lag between the reference sound signal and the captured audio signal(s). The recalibration process comprises the microphone controller analyzing the waveform of the reference sound signal and determining whether there is a delay. If there is a delay, as one non-limiting example, the microphone system 116 may use, e.g., a lip-sync device to resync the reference sound signal. In another non-limiting example, a mixer 210 may synchronize the captured audio signal relative to the reference sound signal. The synchronization may be performed based on one or more parameters, such as (but not limited to) the distance between the mixer 210 and speakers 118, the distance between the mixer and microphone system 116, the type of path between the mixer 210, speakers 118, and/or microphone system 116, etc.). Although a recalibration process may be implemented, the active noise cancellation of the disclosure may accurately decipher human speech without requiring that a calibration process be performed (the methods disclosed herein may exclude a calibration process).

Aspects of the disclosure include other configurations for an audio system, such as one comprising additional components, one that communicates the reference sound signal to the microphone system 116 directly from an audio converter 630 and/or 634, and one that comprises a microphone system 116 that both plays sounds and captures the audio signal, as non-limiting examples.

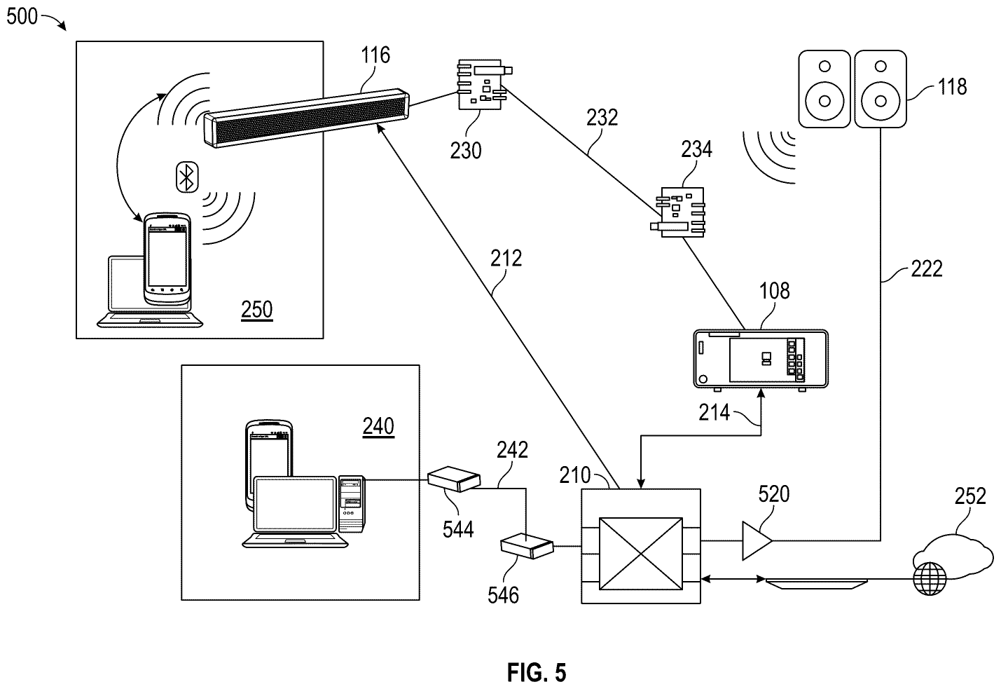

FIG. 5 illustrates a block diagram of an example audio system comprising additional components, according to some aspects. The audio system 500 may comprise an encoder 544 and a decoder 546 that encodes and decodes the source audio signal. The encoder 544 and the decoder 546 are located along path 242 between the computing device 240 and the audio mixer 210. Path 242 communicatively couples the encoder 544 and decoder 546 to the sound source via a line, Ethernet, or XLR cable. Additionally or alternatively, the audio system 500 comprises an amplifier 520 that amplifies the speaker audio signal communicated to the speakers 118.

In some aspects, the audio system 500 communicates using SDVoE. In some aspects, SDVoE communication capabilities may allow integration of the audio system 500 with other components of an operating room 100, including switches, for example. The encoder 544 and the decoder 546 may be an audio/video over IP encoder and an audio/video over IP decoder, respectively, that are communicatively coupled to the sound source. Aspects of the disclosure may comprise communicating audio signals using Ethernet to a plurality of computing devices so that they can be processed simultaneously.

The audio system 500 may perform one or more steps of method 400. In some aspects, step 402 (receive a source audio signal) comprises an audio mixer 210 receiving a source audio signal from a sound source (e.g., computing device 240). In some aspects, step 402 further comprises encoding and/or decoding the source audio signal. Step 404 may comprise the audio mixer 210 generating the reference sound signal and speaker audio signal based on the source audio signal. Step 406 may comprise the audio mixer 210 communicating the reference sound signal directly to the microphone system 116 (path 212), and step 408 may comprise the audio mixer 210 and/or amplifier 520 communicating the audio signal to the speakers 118 (path 222). The speakers 118 may comprise playing the sounds associated with the audio signal (step 410). Step 412 may comprise the microphone system 116 capturing the sounds within the medical environment. The microphone system 116 may modify the captured audio signals by performing active noise cancellation using the captured audio signals and the reference sound signal (step 414). Additionally or alternatively, the microphone system 116 may perform a beam forming process where the captured audio signals are spatially filtered from multiple directions around the microphone system 116, removing or reducing unwanted voices and noises. The microphone system 116 communicates the modified audio signal to the computing device 108 (path 232). The computing device 108 modifies the modified audio signal in step 414. For example, the computing device 108 may further attenuate the modified audio signal, perform reverb reduction or removal, etc. In step 416, the computing device 108 causes one or more actions corresponding to a noise-cancelled audio signal.

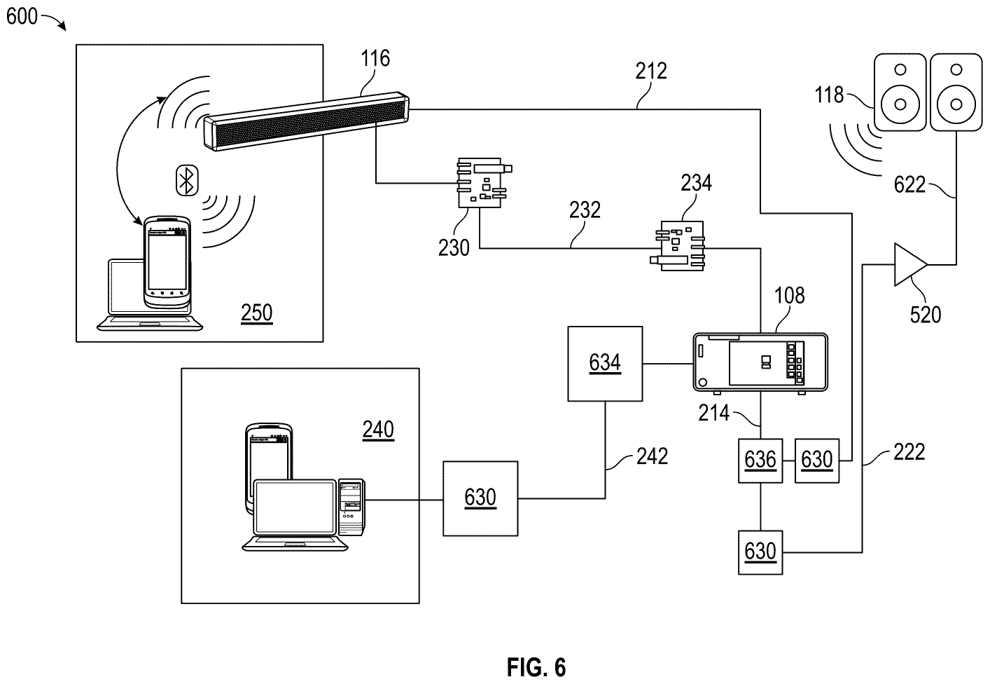

FIG. 6 illustrates a block diagram of an example audio system that communicates the reference sound signal to the microphone system 116 directly from an audio converter 630 and/or 634, according to some aspects. The audio system 600 comprises one or more audio converters 630 and 634 for converting the source audio signal, reference sound signal, and/or speaker audio signal from one format to another format (e.g., a digital video and analog signal converted to an IP signal, an IP signal converted to a digital video and analog signal, etc.). The audio converters 630 and/or 634 are communicatively coupled to the sound source and are located along paths 242 (between the computing device 240 and computing device 108). Additionally or alternatively, audio converters 630 and/or 634 are located along path 222 (between the computing device 108 and amplifier 520). Path 242, path 222, and/or path 622 may comprise a line, Ethernet, or an XLR cable. The lengths of the paths of the audio system 600 may be any length suitable for communicating signals with minimal or no signal loss or delays. For example, at least two of the audio converters 630 and/or 634 are connected through a path (including, but not limited to, path 242, path 214, and/or path 222) having a length that is less than 102 feet. The length of the path 622 may be less than 75 feet.

The audio system 600 may exclude one or more components, including, but not limited to, an audio mixer 210, an encoder 544 or decoder 546, or corresponding paths. As one non-limiting example, the audio system 600 may not include an audio mixer (e.g., audio mixer 210 of audio system 200 (FIG. 2)). The source audio signal from a sound source (e.g., computing device 240) may be communicated to the computing device 108 using path 242. The computing device 108 communicates the source audio signal to a splitter 636, which then receives the source audio signal from the sound source and generates the reference sound signal and speaker audio signal based on the source audio signal. Optionally, at least one audio converter 630 converts the reference sound signal from one format to another format and communicates the converted reference sound signal to the microphone system 116 via path 212. Optionally, at least one audio converter 630 converts the speaker audio signal from one format to another format and communicates the converted speaker audio signal to an amplifier 520 and speakers 118 via path 222 and path 622.

The audio system 600 may perform one or more steps of method 400. In some aspects, step 402 (receive a source audio signal from a sound source) may comprise performing one or more conversions of the audio signal using audio converter 630 and/or audio converter 634. In the example configuration of FIG. 6, the source audio signal is received by the computing device 108. In some aspects, in step 404, a splitter 636 generates the reference sound signal and the speaker audio signal. The reference sound signal may correspond to the speaker audio signal. In steps 406 and 408, audio converters 630 communicate the signals to the microphone system 116 and speakers 118, respectively. The reference sound signal is communicated to the microphone system 116 directly from the audio converter 630. Step 408 may further comprise an amplifier 520 amplifying the speaker audio signal.

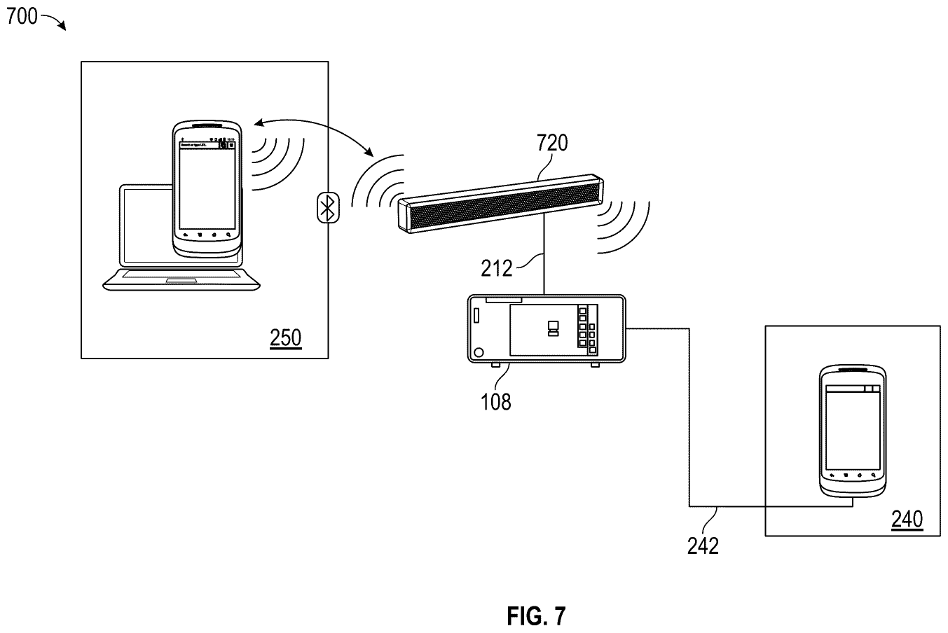

In some aspects, the microphone system 116 comprises the one or more speakers that play the sound corresponding to the speaker audio signal. FIG. 7 illustrates a block diagram of an example audio system 700 and microphone system 720 comprising one or more speakers, according to some aspects. The microphone system 720 may perform multiple functions such as playing a sound and capturing an audio signal within the medical environment. In some aspects, at least a portion of the audio signal captured by the microphone system 720 comprises the sound played by the speakers. The microphone system 720 may be communicatively coupled to a computing device 250 using, e.g., a Bluetooth connection.

Additionally or alternatively, in some aspects, the computing device 108 receives a source audio signal from a sound source such as a computing device 240 (e.g., a mobile phone), communicated along path 242. Path 242 may comprise a wired (e.g., analog or digital audio line) or wireless (e.g., Bluetooth) connection. In some aspects, the microphone system 720 is communicatively coupled to the computing device 108 using path 212. The source audio signal, comprising the reference sound signal and the speaker audio signal, is communicated to the microphone system 720 using path 212. As one non-limiting example, path 212 may comprise a USB connection.

The audio system 700 may exclude one or more components, including, but not limited to, an audio mixer 210, dedicated speakers 118 (separate from a microphone system), converters 230 or 234, an amplifier 520, an encoder 544 or decoder 546, audio converters 630 or 634, corresponding paths, or a combination thereof.

The audio system 700 may perform one or more steps of method 400. For example, step 402 (receive a source audio signal) comprises receiving a source audio signal from a computing device 240 (e.g., mobile phone). In some aspects, the method performed by audio system 700 may exclude step 404 (generate the reference sound signal and the speaker audio signal), step 406 (communicate the reference sound signal to a microphone system), and/or step 408 (communicate the speaker audio signal to the speakers). Alternatively, the microphone system 720 may perform steps 404, 406, 408, or a combination thereof. The signal communicated by the computing device 108 to the microphone system 720 may be the source audio signal from the sound source, which may comprise the reference sound signal and the speaker audio signal. Step 412 may comprise the microphone system 720 capturing the audio signal comprising the sound played by the speaker (included in the microphone system 720), and step 414 may comprise the microphone system 720 modifying the captured audio signal based on the reference sound signal. Alternatively, step 414 comprises the computing device 108 receiving the source audio signal, generating the reference sound signal, receiving the captured audio signal, and then modifying the captured audio signal based on the reference sound signal. In some aspects, step 414 also comprises the computing device 108 further modifying the modified audio signal. In some aspects, the computing device 108 and/or computing device 240 perform step 416 (cause one or more actions corresponding to a noise-cancelled audio signal).

As mentioned above, in some instances, the medical environment comprises equipment that makes noises. The noises may be included in the audio signal captured by a microphone system. Aspects of the disclosure may comprise one or more additional microphones or microphone systems for capturing the noises from the equipment. The additional microphone(s) or microphone system(s) may be located proximate to the equipment. In some aspects, the reference sound signal comprises the captured noise. For example, the additional microphone(s) may send an audio signal corresponding to the captured noise to the audio mixer 210 or computing device 108 to be included in the reference sound signal communicated to the microphone system 116 or 720. Additionally or alternatively, the computing device 108 may modify the modified audio signal based on the captured noise. In some aspects, for each of the plurality of reference sound signals, the microphone system 116/720 and/or computing device 108 cancels noise from the captured audio signal using the reference sound signal to form a noise-cancelled audio signal. The computing device 108 then selects the noise-cancelled audio signal (among the plurality of modified audio signals) having the best speech quality.

As discussed above, the systems and methods described herein capture human speech within a medical environment. In some aspects, the human speech may be used as a voiceprint to automatically identify the voice of one or more users. In some aspects, each user has a unique voiceprint. The voiceprint may enable authentication of the user, such as a surgeon or medical staff. The systems and methods may operate in a plurality of modes including, but not limited to, voiceprint enrollment and voiceprint authentication.

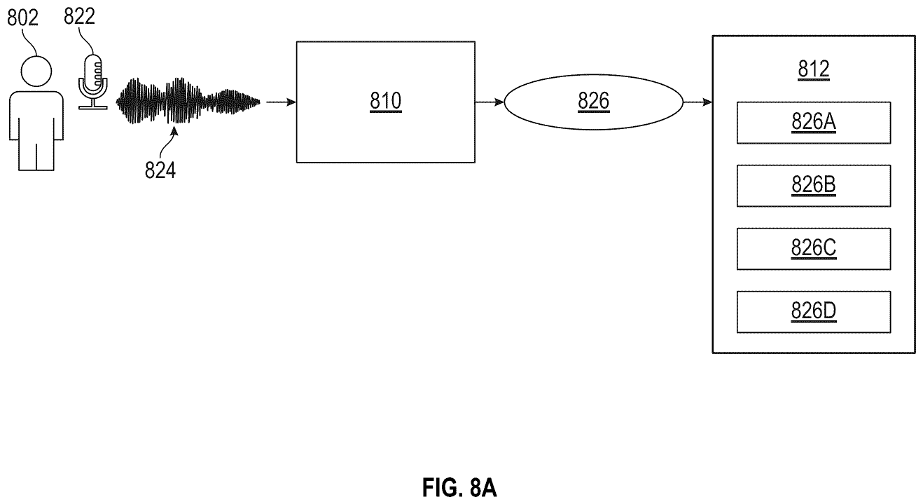

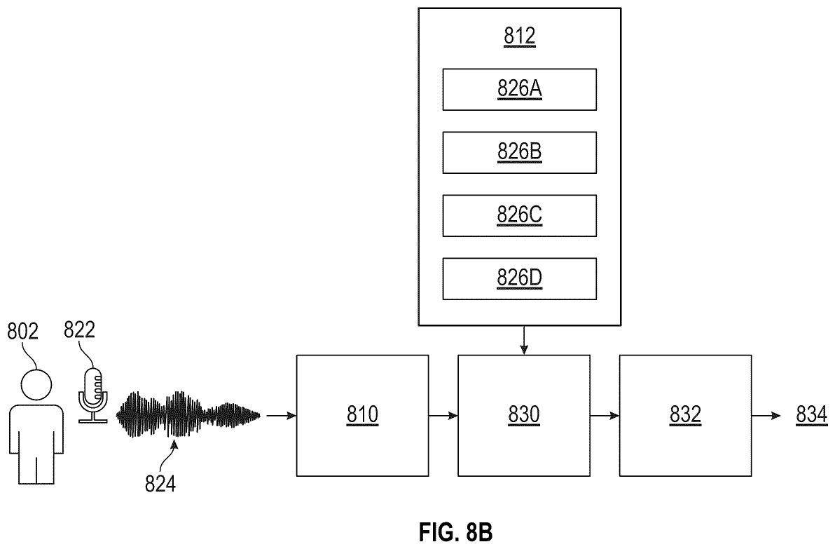

FIG. 8A illustrates an example block diagram depicting a voiceprint enrollment mode, according to some aspects. The voiceprint enrollment mode may be used when adding a new voiceprint and associating the new voiceprint to a user. The system comprises a user 802, a model 810, and a database 812. The user 802 provides human speech, which is captured by a microphone 822. The model 810 receives the human speech (sound signal 824) and extracts features (e.g., represented as one or more feature vectors) from the captured user's voice. The voiceprint 826 may comprise the extracted features. The model 810 may be a model, such as an artificial intelligent model, a machine-learning model, or the like, comprising a neural network. The model 810 may extract the voiceprint 826 (e.g., from the sound signal 824) and represent the voiceprint 826 using one or more feature vectors. The feature vector(s) may be used to associate the voiceprint 826 to a specific user. The database 812 may store one or more voiceprints 826A, 826B, 826C, 826D, etc. for future use.

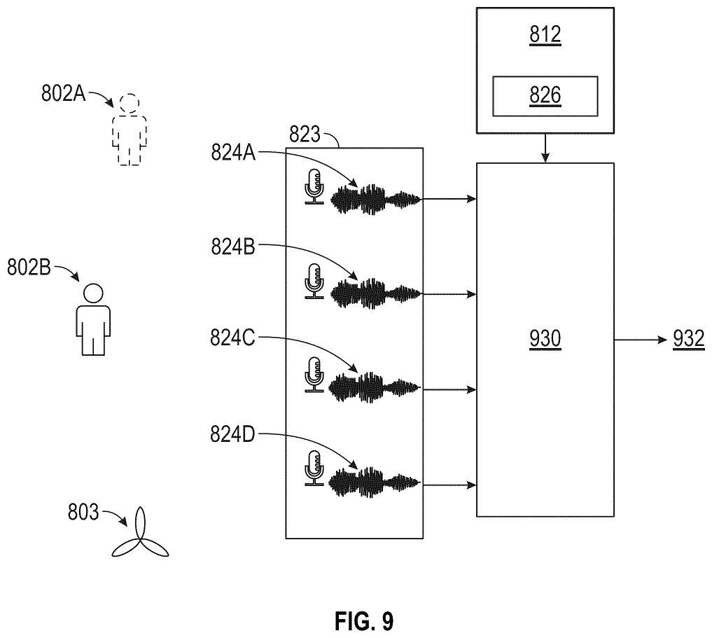

FIG. 8B illustrates an example block diagram depicting a voiceprint authentication mode, according to some aspects. The voiceprint authentication mode may be used when verifying the human speech of a user. In some aspects, the voiceprint authentication may be used when a user has an associated voiceprint 826 stored in the database 812, e.g., after voiceprint enrollment. The user 802 may provide human speech (sound signal 824), captured by a microphone 822, to the model 810. The model 810 may receive the human speech and then extract features from the captured voice. The model 810 may classify (at block 830) the extracted features from the sound signal 824 and a reference vector of a voiceprint 826 from the database 812 to identify whether the user's speech matches one of the voiceprints 826 stored in the database 812 (at block 832). In some aspects, the model 810 may generate a single value (output 834) indicating a match between a user's speech and one of the voiceprints 826 stored in database 812. For example, the model 810 may generate output 834 comprising a binary “1” or “0” indicating that there is a match or is not a match, respectively. Other examples of output 834 generated by the model 810 may be or include a probability distribution indicating a likelihood that there is a match between a user's speech and one of the voiceprints 826 stored in database 812, a class label indicating a verified user or an unverified user, a series of continuous and/or discrete values corresponding to a user's credentials and/or history of previous authentications, and/or any output suitable for verifying the human speech of a user. If the sound signal 824 is verified, the system may identify a user profile that corresponds to the voiceprint 826 associated with the verified sound signal 824. If the sound signal 824 is not verified, the system may restrict the user from accessing the system. For example, the system may restrict the user from log in, cause a lock screen on one or more devices, cause notification to medical staff, and/or any other action suitable for mitigating unauthenticated access to the system. In some aspects, the voiceprint of one or more users may be used to enhance noise reduction. FIG. 9 illustrates a block diagram of an example system configured for using one or more voiceprints for noise reduction, according to some aspects. The system may receive multiple sound signals 824A, 824B, 824C, and 824D, such as human speech from a first user 802A (e.g., a surgeon), human speech from a second user 802B (e.g., a nurse), and other sources of noise 803 (e.g., equipment noise), via one or more microphones 823. In some aspects, the microphones 823 may comprise a linear/circular microphone array that implements beamforming, or a set of spatially-separated distributed microphones (e.g., installed at various locations in the operating room). For example, the microphones 823 may include a linear microphone array comprising, e.g., four linearly-aligned microphones, or could alternatively include a different number of linearly-aligned microphones, e.g., at least two microphones that are vertically spaced from each other by a distance on the order of 2 to 5 centimeters or so. In some implementations, the microphones could be horizontally offset from each other rather than being directly in line with each other, but would still be vertically spaced from each other. The microphones of the linear array could be digital microphones configured to receive acoustic input and to convert the acoustic input into a stream of digital samples for processing.

In use, the linear microphone array may be oriented vertically. This vertical orientation of the microphone array could help facilitate evaluation of separate microphone audio channels as a basis to determine whether received voice audio is spoken by the user wearing the device or rather by another user. In some implementations, a user may carry a user device, e.g., in a pocket or holster, and the user may then remove the user device and bring it into the optimal position to support providing voice commands and other voice audio.

The system may include an algorithm that separates the sound signals. The sound signals 824 are compared to a voiceprint 826 to determine which sound signal 824 corresponds to the first user 802A, which sound signal 824 corresponds to the second user 802B, and/or which sound signal 824 corresponds to the other sources of noise 803, etc. Examples of the disclosure may include using signal separation (at block 930) to enhance noise reduction. In some aspects, one or more sound signals 824 associated with a user (e.g., first user 802A, second user 802B, or both) may be attenuated. In some aspects, unwanted sources of noise may be cancelled out, resulting in a noise ratio enhanced signal 932.

In some aspects, different sound signals may be associated with different users (speaker diarization), and different users may have access to different components and/or functions of the system. For example, a first user may be a surgeon, and a second user may be a nurse. The surgeon's speech may be associated with the surgeon's voiceprint and profile. The system may identify the surgeon's voice and may be configured to perform steps in accordance with specific voice commands spoken by the surgeon. The nurse's speech may be associated with the nurse's voiceprint. The system may identify the nurse's voiceprint and profile and may be configured to perform steps in accordance with specific voice commands spoken by the nurse. In some aspects, the system may not allow the nurse access to surgeon-specific voice commands, the system may not allow the surgeon access to nurse-specific voice commands, or both. The system may not perform steps for surgeon-specific voice commands (e.g., commands given during the procedure) spoken by the nurse and/or the system may not perform nurse-specific voice commands (e.g., commands to prepare the operating room including testing the equipment, commands to control certain equipment during the procedure) spoken by the surgeon. For example, the surgeon's voiceprint and profile may be associated with voice commands for controlling the computing device 108. The nurse's voiceprint and profile may be associated with verbal transcription/documentation of the procedure. In this manner, the operating room may be optimized based on voice, which may help with voice processing by reducing the number of actions possible for a given user.

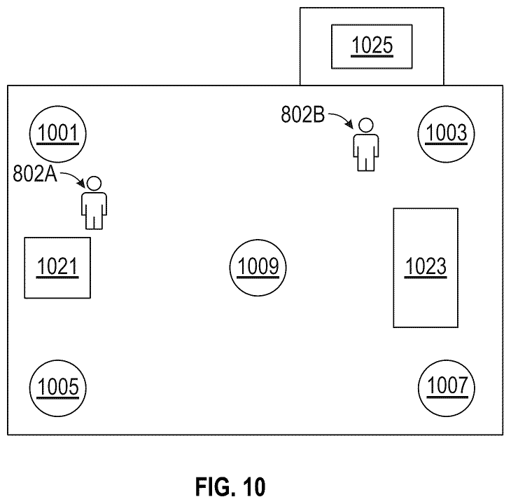

Examples of the disclosure may include using the voiceprints for data collection. The operating room map by be mapped out and data may be collected regarding the locations of the users and/or other sound sources during a procedure. The data may indicate where, e.g., users typically locate themselves during the procedure. This data may be used for designing optimized operating rooms (e.g., supporting increased efficiencies, improved ergonomics, clear communication, and the like). For example, the microphones in the operating room may be located and calibrated based on the typical location of the user(s). The microphones may be calibrated to be more sensitive for specific user voiceprints and profiles in certain areas of the operating room. FIG. 10 illustrates an example configuration of an operating room, according to some aspects of the disclosure. The operating room may include microphones 1001, 1003, 1005, and 1007 located in each corner and a microphone 1009 located in the center. A user 802A may be located near microphone 1001 to operate device 1021 (e.g., a voice controlled surgical pump). A user 802B may be located near microphone 1003 and surgical table 1023. The user 802B may provide voice commands to the device 1025 (e.g., computing device 108 located in a storage/electrical closet). The system may learn (e.g., using artificial intelligence or machine learning) that user 802A is typically located near microphone 1001 and user 802B is typically located near microphone 1003 during the procedure. The system may configure microphone 1001 to be more sensitive to user 802A and microphone 1003 to be more sensitive to user 802B. For example, the system may attenuate the sound signals not identified by the respective voiceprints of the users 802A and 802B. In some aspects, the sound signals may be attenuated using hardware (e.g., manually increasing the sensitivity of the microphone using a hardware component and/or constructive interference). In some aspects, the sound signals may be attenuated using one or more software applications (e.g., using active noise cancellation).

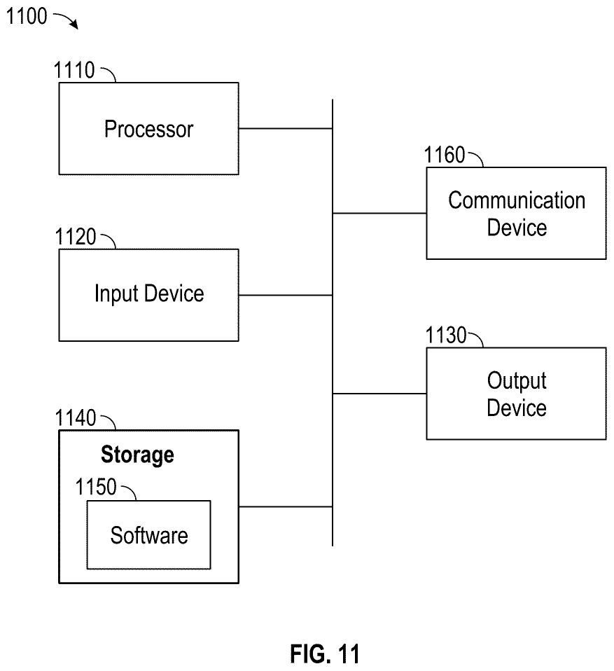

FIG. 11 illustrates an example computing system, in accordance with some examples, that can be used for performing any of the methods described herein, including method 400 of FIG. 4, and can be used for any of the systems described herein, including the audio systems 200, 500, 600, and 700 of FIGS. 2, 5, 6, and 7, respectively. System 1100 can be a computer coupled to a network, which can be, for example, an operating room network or a hospital network. System 1100 can be a client computer or a server. As shown in FIG. 11, system 1100 can be any suitable type of controller (including a microcontroller) or processor (including a microprocessor) based system, such as an embedded control system, personal computer, workstation, server, or handheld computing device (portable electronic device) such as a phone or tablet. The system can include, for example, one or more of processor 1110, input device 1120, output device 1130, storage 1140, or communication device 1160.

Input device 1120 can be any suitable device that provides input, such as a touch screen, keyboard or keypad, mouse, gesture recognition component of a virtual/augmented reality system, or voice-recognition device. Output device 1130 can be or include any suitable device that provides output, such as a touch screen, haptics device, virtual/augmented reality display, or speaker.

Storage 1140 can be any suitable device that provides storage, such as an electrical, magnetic, or optical memory including a RAM, cache, hard drive, removable storage disk, or other non-transitory computer-readable medium. Communication device 1160 can include any suitable device capable of transmitting and receiving signals over a network, such as a network interface chip or device. The components of the computer can be coupled in any suitable manner, such as via a physical bus or wirelessly.

Software 1150, which can be stored in storage 1140 and executed by processor 1110, can include, for example, the programming that embodies the functionality of the present disclosure (e.g., as embodied in the devices as described above). For example, software 1150 can include one or more programs for performing one or more of the steps of the methods disclosed herein.

Software 1150 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1140, that can contain or store programming for use by, or in connection with, an instruction execution system, apparatus, or device.

Software 1150 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport readable medium can include, but is not limited to, an electronic, magnetic, optical, electromagnetic, or infrared wired or wireless propagation medium.

System 1100 may be coupled to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 1100 can implement any operating system suitable for operating on the network. Software 1150 can be written in any suitable programming language, such as C, C++, C #, Java, or Python. In various examples, application software embodying the functionality of the present disclosure can be deployed in different configurations, such as in a client/server arrangement or through a Web browser as a Web-based application or Web service, for example.

The foregoing description, for the purpose of explanation, has been described with reference to specific aspects. However, the illustrative discussions above are not intended to be exhaustive or to limit the invention to the precise forms disclosed. Many modifications and variations are possible in view of the above teachings. The aspects were chosen and described in order to best explain the principles of the techniques and their practical applications. Others skilled in the art are thereby enabled to best utilize the techniques and various aspects with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A method of performing active noise cancellation in a medical environment, the method comprising:
playing, by one or more speakers, a sound within the medical environment;
capturing, using a microphone system, an audio signal comprising the sound played by the one or more speakers;
receiving, at the microphone system, a reference sound signal from a reference source; and
modifying at least a portion of the captured audio signal based on the reference sound signal.

2. The method of claim 1, further comprising:
receiving a source audio signal from a sound source, wherein the sound source is communicatively coupled to the reference source.

3. The method of claim 1, further comprising:
receiving a source audio signal from a sound source; and
encoding and decoding, using an encoder and a decoder, the source audio signal, wherein the sound source is communicatively coupled to the encoder and the decoder.

4. The method of claim 1, further comprising:
receiving a source audio signal from a sound source; and
converting, using one or more audio converters, the source audio signal from one format to another format, wherein the sound source is communicatively coupled to the one or more audio converters.

5. The method of claim 1, further comprising:
receiving a source audio signal from a sound source; and
generating the reference sound signal and a speaker audio signal based on the source audio signal, wherein the speaker audio signal corresponds to the sound played by the one or more speakers.

6. The method of claim 1, further comprising:
receiving a source audio signal from a sound source; and
communicating the source audio signal to the microphone system, wherein the source audio signal comprises the reference sound signal and a speaker audio signal corresponding to the sound played by the one or more speakers.

7. The method of claim 1, further comprising:
communicating or amplifying a speaker audio signal corresponding to the sound played by the one or more speakers.

8. The method of claim 1, further comprising:
converting the modified audio signal from: an optical signal to an electrical signal, an electrical signal to an optical signal, or both.

9. The method of claim 1, wherein modifying at least a portion of the captured audio signal comprises: modifying the captured audio signal using both the microphone system, a computing device, or both; or
processing the modified audio signal using speech recognition, recording speech as an audio file, communicating speech to another device, or a combination thereof.

10. A system for performing active noise cancellation in a medical environment, the system comprising:
one or more speakers that play a sound within the medical environment;
a path for communicating a reference sound signal from a reference source to a microphone system; and
the microphone system comprising:
a microphone that captures an audio signal comprising the sound played by the one or more speakers; and
a microphone controller that modifies at least a portion of the captured audio signal based on the reference sound signal.

11. The system of claim 10, further comprising:
a sound source that generates a source audio signal, wherein the sound source comprises a computing device.

12. The system of claim 10, further comprising:
an encoder and a decoder that encodes and decodes a source audio signal from a sound source.

13. The system of claim 10, further comprising:
a plurality of audio converters that convert a source audio signal from a sound source from one format to another format, wherein at least two of the plurality of audio converters are connected through a path having a length that is less than 102 feet.

14. The system of claim 10, further comprising:
an audio mixer that:
receives a source audio signal from a sound source; and
generates the reference sound signal and a speaker audio signal based on the source audio signal, wherein the speaker audio signal corresponds to the sound played by the one or more speakers.

15. The system of claim 10, further comprising:
a computing device communicatively coupled to the microphone system through a path having a length that is less than 328.08 feet.

16. The system of claim 10, further comprising:
an optical-to-electrical converter that converts the modified audio signal from an optical signal to an electrical signal; or
an electrical-to-optical converter that converts the modified audio signal from an electrical signal to an optical signal.

17. The system of claim 10, further comprising:
one or more additional microphone systems that capture noises from equipment within the medical environment, wherein the reference sound signal comprises the captured noise.

18. The system of claim 10, further comprising:
a computing device that:
receives a plurality of modified audio signals from a plurality of microphone systems; and
selects a noise-cancelled audio signal having the best speech quality from among the plurality of modified audio signals.

19. A suspension comprising:
a microphone system comprising:
one or more speakers that play a sound within a medical environment;
a microphone that captures an audio signal comprising the sound played by the one or more speakers; and
a microphone controller that modifies at least a portion of the captured audio signal based on a reference sound signal; and
at least one cable for communicating the captured audio signal, the reference sound signal, and the modified audio signal.

20. The suspension of claim 19, wherein the at least one cable is routed through the suspension.
